(19) United States
(12) Patent Application Publication
(10) Pub. No.: US 2019/0321751 A1
(43) Pub. Date: Oct. 24, 2019

(54) FILTER INSERT FOR A WATER TREATMENT DEVICE

(71) Applicant: Ettore Products Co., Alameda, CA (US)

(72) Inventor: Steffen Orben, Kronberg (DE)

(21) Appl. No.: 16/391,186

(22) Filed: Apr. 22, 2019

(30) Foreign Application Priority Data
Apr. 20, 2018 (EP) 18168382.2

(51) Int. Cl. B01D 15/10; C02F 1/42; B01D 15/36

(52) U.S. Cl. CPC B01D 15/10; C02F 2201/006; B01D 15/361; C02F 1/42

(57) ABSTRACT

An improved filter insert for a water treatment device comprises a pouch made of a mesh sheet having an elongation at break less than one hundred percent and the pouch delimiting an internal volume in which a water treatment agent is disposed.

### CROSS-REFERENCE TO RELATED APPLICATIONS

This application claims the benefit of European Patent Application No. 18168382.2, filed Apr. 20, 2018, the contents of which are incorporated herein by reference.

### BACKGROUND

### Field of the Invention

This invention relates to a filter insert for a water treatment device.

### Discussion of the Prior Art

Water treatment devices are used for cleaning or filtering water. The cleaning or filtration of water is generally understood as meaning the decalcification and desalination of water, as well as the adjustment of water to a specific pH. In many cases, this is intended to produce demineralized water. Demineralized water is used, among other things, in heating systems, in chemical or pharmaceutical laboratory operations and as a cleaning medium for façade or window cleaning.

Various filtering agents can be used in water treatment, including, for example, various resins, which are used in loose form. One example of such a water treatment resin is the Ionac© NM-60 mixed bed ion exchange resin, which is manufactured and sold by Lanxess Aktiengesellschaft. The water to be treated flows through the water treatment agent and is treated (cleaned or filtered) in the process.

Water treatment devices of this kind often comprise a housing in which the water treatment agent is disposed. The housing has an inlet and an outlet, being arranged, for example, opposite each other in relation to the housing, so that a flow of water is created through the water treatment agent disposed within the housing.

Over time, the water treatment agent is consumed so that, after a service life, a replacement of the water treatment agent is required. The overall volume of the water treatment agent diminishes over the service life, for example, by as much as 20% in the case of the Ionac© NM-60 resin.

Since the handling of loose material is laborious and time-consuming in practice, water treatment devices exist in which the water treatment agent is provided in a pouch or insert. The water treatment agent is inserted into the water treatment device together with the insert, the insert being made of a mesh sheet so that water can flow through its walls. Corresponding devices are known, for example, from U.S. Pat. No. 2,278,488 (“Ralston”).

In Ralston, the filter insert for a water treatment device is made of a flexible woven fabric sheet configured to expand by virtue of the water treatment agent contained therein and to conform to the internal surface of the housing. The goal is for the insert to cling to the internal surface of the housing to prevent water from flowing along the outside of the insert, thereby leaving the housing without being treated.

The use of filter inserts improves the handling and replacement of water treatment agents, but during insertion and removal of the insert and other handling, it is common for some of the water treatment agent to be lost as individual particles escape through the mesh openings in the filter insert material. This is typically observed when the particles of the water treatment agent are still dry or have become crushed due to abrasion. The loss of water treatment agent during handling decreases the effectiveness of the water treatment device.

The present invention provides an improved filter insert for the handling and replacement of a water treatment agent.

### SUMMARY OF THE INVENTION

The invention is an improved filter insert for a water treatment device comprising a pouch made from a mesh sheet. Notably, the mesh sheet has a relatively low elongation at break (ε_{R}). Elongation at break is a material property that measures a material's ductility or its ability to resist changes of shape without breaking. With a higher elongation at break, a material can withstand a higher level of bending and shaping before breaking. By reducing the elongation at break (i.e., reducing the material's ductility), the material is less capable of stretching or bending and therefore its mesh openings are less prone to expanding in size or shape. This increased control over the size and shape of the mesh openings reduces the amount of water treatment agent lost through the mesh openings during handling.

### BRIEF DESCRIPTION OF THE DRAWINGS

FIG. 1 shows a first embodiment of a filter insert for a water treatment device according to the invention.

FIG. 2 is a close-up view of a sheet that forms the pouch of a filter insert according to the invention.

FIG. 3 shows a second embodiment of a filter insert for a water treatment device according to the invention.

FIG. 4 shows a third embodiment of a filter insert for a water treatment device according to the invention.

FIG. 5 is an exploded view of a filter insert according to the invention and a water treatment device.

### DETAILED DESCRIPTION OF THE ILLUSTRATED EMBODIMENTS

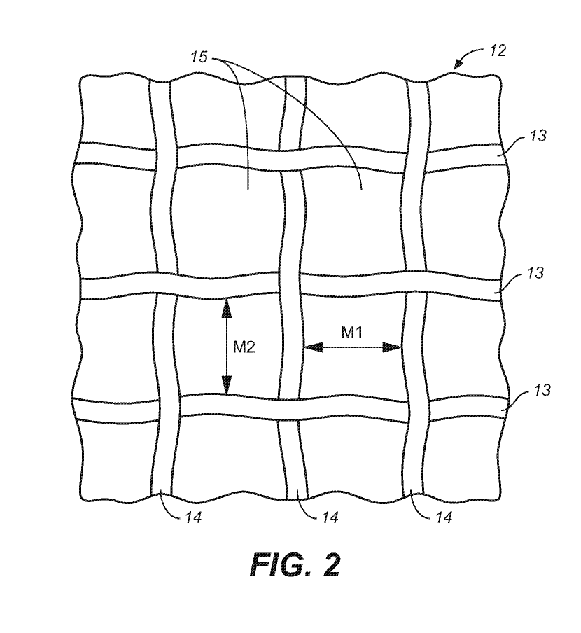

Referring now to the drawings, a filter insert 10 for a water treatment device according to the invention comprises a pouch 20 made of at least one mesh sheet 12 (FIG. 2). In the illustrated embodiment, pouch 20 comprises a bottom wall 22, a side wall 24 and a lid wall 26 joined together by means of seams 28, which together delimit an internal volume in which a water treatment agent is to be disposed.

FIG. 2 shows a close-up view of a portion of sheet 12 used to make the walls of pouch 20. Sheet 12 is an elastic and flexible mesh sheet, where “elastic” pertains to the sheet's ability to resume its normal shape after being stretched or compressed (“stretchiness”) and “flexible” pertains to the sheet's ability to bend easily without breaking (“ductility”). Elasticity is generally dictated by the material used to make the sheet, while flexibility results from its manufacture (for example, a woven fabric). In previously known filter inserts, mesh openings in the sheet become larger as the filter insert is handled due to the elasticity and flexibility of the sheet. In this way, particles of the water treatment agent may escape through the mesh openings of the filter insert and thus escape into the housing. By using an elastic and flexible sheet 12 with an elongation at break (ε_{R}) of less than 100%, the filter insert 10 of the present invention can limit the enlargement of the mesh openings of sheet 12 and thus can limit the overall loss of water treatment agent particles through the openings during handling.

To determine the elongation at break, a sample of a sheet with an initial length L_{O} and a width B is clamped in a tensile testing machine and loaded up to tearing (also called breaking) with a tensile force. Once the sample breaks into two pieces, the sample is fitted together, and its length is measured once again. At breaking, the sample is loaded with a breaking force F_{B} and has a length LB when fitted together. The elongation at break (ε_{R}) is thus calculated as follows:

$${ɛ}_{R} = \frac{{L}_{B} - {L}_{0}}{{L}_{0}} \cdot 100 \%$$

The elongation at break (ε_{R}) of sheet 12 is preferably less than 70% and especially preferably less than 50%. The lower the elongation at break, the less the openings in sheet 12 can enlarge and thus the overall loss of water treatment agent particles through the openings during handling is reduced. A reduction in the elongation at break of sheet 12 is achieved through a combination of material selection and manufacture.

Sheet 12 is formed of a plastic material, especially at least partly of a thermoplastic material. In one embodiment, sheet 12 is formed entirely of a plastic material, especially a thermoplastic material. Plastic materials are well suited to making sheets with an elongation at break less than 100%, since they can be easily worked and are economical. Furthermore, they are not sensitive to contact with water and thus are suitable for the cleaning and/or filtering of water.

Sheet 12 may, for example, be at least partly formed from a plastic such as acrylonitrile-butadiene-styrene (ABS), polyamide (PA), polylactide (PLA), polymethylmethacrylate (PMMA), polycarbonate (PC), polyethylene terephthalate (PET), polyethylene (PE), polypropylene (PP), polystyrene (PS), polyetheretherketone (PEEK), or polyvinyl chloride (PVC).

In the illustrated embodiment, sheet 12 has a lattice-like structure. In this way, the openings 15 in sheet 12 can be distributed evenly so that a uniform flow of water through sheet 12 is possible. Specifically, sheet 12 is illustrated as a woven fabric in which warp threads 13 and weft threads 14 are woven together. All the warp threads 13 are arranged in parallel to each other, as are all the weft threads 14. The warp threads 13 are shown arranged at an angle of 90° to the weft threads 14.

Sheet 12 may be produced by means of extrusion. Extrusion can be used to produce sheet 12 as a single piece (with no additional process steps), which simplifies the manufacturing process and reduces cost.

In some embodiments, sheet 12 is formed from a plurality of threads 13, 14. This makes possible many different sheet designs. The threads 13, 14 of sheet 12 may be fixed to each other by means of heat treatment. In this way, a portion of the flexibility would be removed from sheet 12, since the threads 13, 14 would not be able to move relative to each other. In this way, a lower elongation at break is achieved.

Sheet 12 may be a scrim, woven, crocheted, braided or knitted fabric. In contrast to sheets based on fibers, such as felt or fleece, a sheet of scrim, woven, crocheted, braided or knitted fabric can have a more controlled mesh size.

Sheet 12 may have different mesh sizes in different directions within the sheet. In the illustrated example, the warp threads 13 and the weft threads 14 form substantially rectangular openings 15 through which water can flow, with the openings 15 having a first mesh size M1 in a direction parallel to the warp threads 13 and a second mesh size M2 in a direction parallel to the weft threads 14. The mesh size M1 corresponds to the distance of the individual weft threads 14 from each other and the mesh size M2 corresponds to the distance of the individual warp threads 13 from each other.

Preferably, sheet 12 has mesh sizes M1, M2 in each direction of between approximately 100 μm and 1000 μm. This range of mesh size is suitable for use with ion exchange resins. The mesh sizes are preferably between 100 μm and 500 μm and especially preferably between 100 μm and 300 μm. These preferred ranges of mesh size optimize the flow through the openings to be as large as possible, yet as small as needed in order to minimize the loss of water treatment agent.

To optimize flow rate, the total of the areas of the mesh openings 15 in sheet 12 in relation to the total area of the sheet 12 (referred to herein as the “screen area” S) should be at least about 30%.

Sheet 12 has a material thickness between about 100 μm and 500 μm. Sheets in this range of material thicknesses are sufficiently sturdy for handling, yet less material-intensive than thicker sheets. Preferably, the material thickness of sheet 12 is between a 100 μm and 300 μm.

In order for the filter insert 10 to have an adequate service life, sheet 12 must have adequate tear strength (or tear resistance), which is a measure of how well the sheet material can withstand the effects of tearing. Sheet 12 has a tear strength ρR greater than about 200 N/5 cm (Newtons per 5 centimeters). Preferably, the tear strength ρR is greater than about 400 N/5 cm, and especially preferably tear strength ρR is greater than about 500 N/5 cm.

The tear strength of sheet 12 is based on the width B of a 5 cm long sample of the sheet material and the tensile strength F_{B} applied to the sample at the moment of breaking. Thus, tear strength of the sheet material is calculated as follows:

$${ρ}_{R} = \frac{{F}_{B}}{B}$$

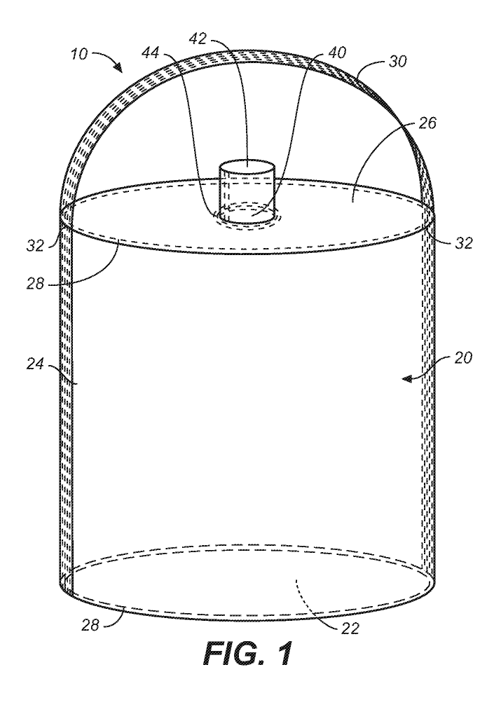

Returning to FIG. 1, a handle or a grip element 30 may be attached to pouch 20, for example by seams 32, for improved handling of the filter insert 10. In the illustrated embodiment, handle 30 is joined to the side wall 24 and extends in the region of the side wall 24 at least partly from the lid wall 26 to the bottom wall 22 to help stabilize filter insert 10. The distance from bottom wall 22 to lid wall 26 is the height of wall 20. Preferably, handle 30 extends for at least half of this distance and especially preferably, and as illustrated, handle 30 extends the full distance from bottom wall 22 to lid wall 26.

In the embodiment shown in FIG. 1, the filter insert 10 has a generally cylindrical shape. In this way, filter insert 10 can stand stably, which is advantageous for handling and insertion into a housing of a water treatment device.

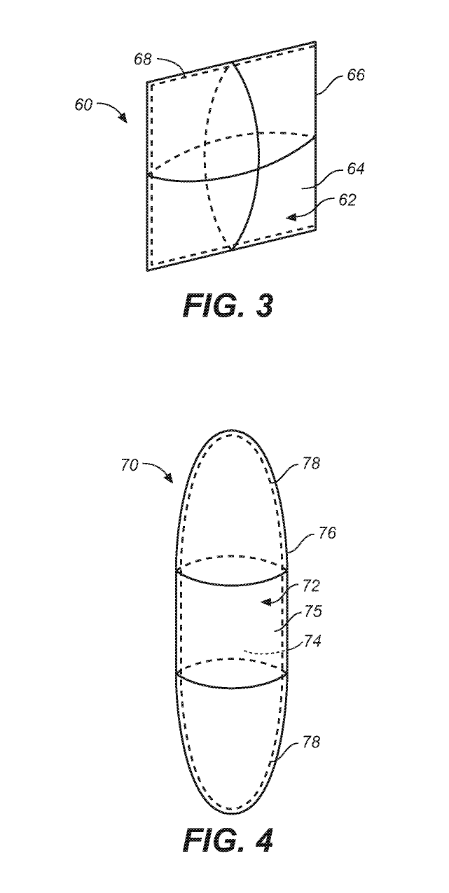

In another embodiment of a filter insert 60 shown in FIG. 3, pouch 62 is made of a single mirror-symmetrical sheet 64, which is folded along a folding edge 66 and closed along the remaining edges by means of a seam 68, thus forming a rectangular, pillow-like shape.

In another embodiment of a filter insert 70 shown in FIG. 4, pouch 72 has a pillow-like shape made of two identical sheets 74, 75, in particular two identical sheets having rounded ends, which are joined together along their outer circumferences by means of a seam 78, thus forming a tubular, pillow-like shape. Pillow-like shapes offer advantages in terms of production, since fewer process steps are needed to produce them.

The pouch of a filter insert according to the invention thus may comprise more than one sheet, which can be joined together in various ways, such as by stitching or welding.

With reference again to FIG. 1, pouch 20 of filter insert 10 has an opening 40 for filling and emptying the filter insert 10. Opening 40 is preferably located in an end region of pouch 20. Since the water treatment agent can be replaced, filter insert 10 is reusable and recyclable.

Opening 40 may be closed by means of a nozzle or other closure element 42 to avoid a loss of water treatment agent through opening 40 during transport and handling. The closure element 42 can be, for example, a cable tie or, alternatively, a tamper-evident closure element can be used to detect unauthorized filling or emptying of the filter insert.

A water treatment device having a housing can receive a filter insert according to the above embodiments. Preferably, an interior space of the housing of the water treatment device corresponds in shape and size to the pouch of the filter insert.

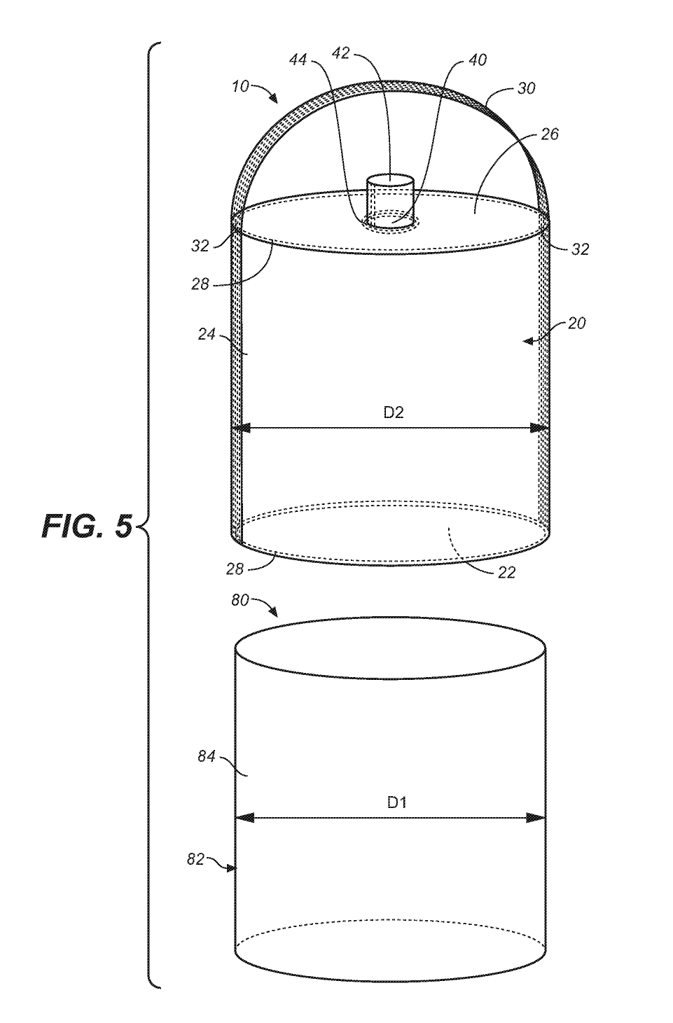

FIG. 5 shows an exemplary water treatment device 80 and a filter insert 10. In this embodiment, the housing 84 of the water treatment device 80 has a cylindrical base shape with a first diameter D1 and the wall of the filter insert has a cylindrical base shape with a second diameter D2 greater than D1. In this way, filter insert 10 is oversized in relation to the housing 80, so that filter insert 10 can fit snugly against housing 80 to compensate for the reduced flexibility of pouch 20 due to the relatively low elongation at break of its walls. Not shown are a bottom and a lid of housing 84, which would have an inlet for the medium (water) to be cleaned and an outlet for the cleaned medium.

There have thus been described and illustrated certain embodiments of a filter insert for a water treatment device according to the invention. The illustrated embodiments are merely example implementations of the invention and are not to be taken as limiting, the spirit and scope of the invention being limited only by the terms of the appended claims and their legal equivalents.

What we claim is:

1. A filter insert for a water treatment device comprising:
a pouch made of at least one water-permeable sheet, the sheet having an elongation at break less than one hundred percent, and the pouch delimiting an internal volume in which a water treatment agent is disposed.

2. The filter insert of claim 1, wherein the sheet comprises a plastic material.

3. The filter insert of claim 2, wherein the sheet comprises a thermoplastic material.

4. The filter insert of claim 2, wherein the sheet comprises at least one plastic material selected from the group consisting of acrylonitrile-butadiene-styrene (ABS), polyamide (PA), polylactate (PLA), polymethylmethacrylate (PMMA), polycarbonate (PC), polyethylene terephthalate (PET), polyethylene (PE), polypropylene (PP), polystyrene (PS), polyetheretherketone (PEEK), or polyvinyl chloride (PVC).

5. The filter insert of claim 2, wherein the sheet comprises a single piece.

6. The filter insert of claim 5, wherein the sheet has an interlaced structure forming uniformly sized mesh openings.

7. The filter insert of claim 6, wherein the mesh comprises a plurality of threads welded together at their intersections.

8. The filter insert of claim 6, wherein the sheet comprises at least one fabric from the group consisting of a scrim, woven, crocheted, braided or knitted fabric.

9. The filter insert of claim 6, wherein the sheet has a mesh size of between about 100 μm and about 1000 μm.

10. The filter insert of claim 9, wherein the sheet has a mesh size of between about 100 μm and about 500 μm.

11. The filter insert of claim 6, wherein the sheet has a tear strength greater than about 200 N/5 cm (Newtons per 5 centimeters).

12. The filter insert of claim 6, wherein the sheet has a screen area of about 30%.

13. The filter insert of claim 1 further comprising:
a handle attached to the pouch of the filter insert.

14. The filter insert of claim 13, wherein the pouch is pillow shaped.

15. The filter insert of claim 13, wherein the pouch has a cylindrical shape.

16. The filter insert of claim 15, wherein the pouch further comprises:
a bottom wall,
a lid wall, and
a side wall extending between the bottom and lid walls, the grip element being joined to the side wall and extending along the side wall at least partly from the lid wall to the bottom wall.

17. A water treatment device comprising:
a housing, and
a filter insert disposed within the housing,
the filter insert including a pouch having at least one water-permeable sheet, the pouch delimiting an internal volume for disposition therein of a water treatment agent, and the sheet having an elongation at break less than one hundred percent.

18. The water treatment device of claim 17, wherein the housing has a cylindrical shape with a first diameter D1 and the pouch of the filter insert has a cylindrical shape with a second diameter D2 greater than the first diameter D1.

19. A filter insert for a water treatment device comprising:
a pouch made of at least one water-permeable sheet, the wall delimiting an internal volume in which a water treatment agent is disposed, the sheet comprising a mesh of thermoplastic material having a mesh size between about 100 μm and about 500 μm, a screen area of about thirty percent, an elongation at break less than one hundred percent, and tear strength of about 200 N/5 cm (Newtons per 5 centimeters).
